(19) United States
(12) Patent Application Publication
(10) Pub. No.: US 2002/0015507 A1
(43) Pub. Date: Feb. 7, 2002

(54) Loudspeaker

(76) Inventors: Neil Harris, Cambridge (GB); Jeffrey Power, Cambridge (GB); Vladimir Gontcharov, Cambridgeshire (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/867,702

(22) Filed: May 31, 2001

Related U.S. Application Data
(60) Provisional application No. 60/208,302, filed on Jun. 1, 2000.
(60) Provisional application No. 60/273,972, filed on Mar. 8, 2001.

(30) Foreign Application Priority Data
May 31, 2000 (GB) 0013030.2
Mar. 8, 2001 (GB) 0105795.9

(51) Int. Cl. H04R 25/00; H04R 1/00

(52) U.S. Cl. 381/431; 381/152

(57) ABSTRACT

A loudspeaker comprising a panel adapted to support bending waves and an exciter for exciting said bending waves employs an exciter having an effective size with which it acts on said panel, the effective size varying in dependence on the frequency with which the exciter acts on the panel. Exciters suitable for use in such a loudspeaker are also disclosed.

This application claims the benefit of U.S. provisional application Nos. 60/208,302, filed Jun. 1, 2000 and 60/273,972, filed Mar. 8, 2001.

### BACKGROUND

The present invention relates to a loudspeaker of the bending wave plate variety and a transducer suited for use in such a loudspeaker.

Loudspeakers comprising an acoustic radiator capable of supporting bending waves and a transducer mounted on the acoustic radiator to excite bending waves in the acoustic radiator to produce an acoustic output are described, for example, in WO97/09842, and in U.S. application Ser. No. 08/707,012, filed Sep. 3, 1996 (the latter incorporated herein by reference). According to these publications, the properties of a “distributed mode” acoustic radiator may be chosen to distribute the resonant bending wave modes substantially evenly in frequency. In other words, the properties or parameters, e.g. size, thickness, shape, material etc., of the acoustic radiator may be chosen to smooth peaks in the frequency response caused by “bunching” or clustering of the modes. The resultant distribution of the frequencies of the resonant bending wave modes may thus be such that there are substantially minimal clusterings and disparities of spacing.

In particular, the properties of the acoustic radiator may be chosen to distribute the lower frequency resonant bending wave modes substantially evenly in frequency. The number of resonant bending wave modes is less at lower frequency than at higher frequency and thus the distribution of the lower frequency resonant bending wave modes is particularly important. The lower frequency resonant bending wave modes are preferably the ten to twenty lowest frequency resonant bending wave modes of the acoustic radiator. The resonant bending wave modes associated with each conceptual axis of the acoustic radiator may be arranged to be interleaved in frequency. Each conceptual axis has an associated lowest fundamental frequency (conceptual frequency) and higher modes at spaced frequencies. By interleaving the modes associated with each axis, the substantially even distribution may be achieved. There may be two conceptual axes and the axes may be symmetry axes. For example, for a rectangular acoustic radiator, the axes may be a short and a long axis parallel to a short and a long side of the acoustic radiator, respectively. For an elliptical acoustic radiator, the axes may correspond to the major and minor axis of the ellipse. The axes may be orthogonal.

The transducer location may be chosen to couple substantially evenly to the resonant bending wave modes. In particular, the transducer location may be chosen to couple substantially evenly to lower frequency resonant bending wave modes. In other words, the transducer may be mounted at a location spaced away from nodes (or dead spots) of as many lower frequency resonant modes as possible. Thus the transducer may be at a location where the number of vibrationally active resonance anti-nodes is relatively high and conversely the number of resonance nodes is relatively low. Any such location may be used, but the most convenient locations are the near-central locations between 38% to 62% along each of the length and width axes of the panel, but off-central. Specific locations found suitable are at 3/7, 4/9 or 5/13 of the distance along the axes; a different ratio for the length axis and the width axis is preferred.

FIGS. 1 to 3 illustrate a number of ways in which such panels can be excited.

The device shown in FIG. 1 is a conventional electrodynamic transducer consisting of a coil 12 fixed to the radiating panel 11, with a magnet 13 suspended within the coil on a soft support 14. When current flows through the coil the magnet moves perpendicularly to the panel and because of inertia a transverse force acts on the panel.

A slightly different arrangement of the conventional transducer is shown in FIG. 2. Here instead of supporting the magnet 23 on a soft suspension, it is joined solidly to the panel 21 by a rigid connector 24. When the coil 22 is powered the magnet applies a force to the panel via the rigid connector. This arrangement is known as a “bender” because there is an equal and opposite reaction force between the coil and the panel, creating a moment.

FIG. 3 shows how two forces applying a moment to a panel will tend to excite different flexural waves according to the distance between them. The arrows represent the forces and it is clear that the response will be largest when the distance between the forces is half the wavelength of the flexural wave. The free flexural wavelength varies with frequency, so the most efficient “bender” transducers would be of different sizes at different frequencies. The two separate views (a) and (b) correspond to two different frequencies and show how the forces need to be separated differently in order to excite with maximum efficiency.

Consider a fixed size transducer which applies a bending moment to the panel and the simple case of two equal and opposite transverse forces, causing the panel to move in flexure, as illustrated for example in FIG. 3(a).

When the forces responsible for the moment are separated by half the wavelength of the wave we wish to excite, then the moment will drive that flexural wave efficiently. A smaller transducer, however will have a reduced efficiency in comparison. If we vary the distance between the two forces continuously then there will be a maximum response in the desired wave when the forces are an odd number of ½ wavelengths apart (i.e. ½ wavelength, 3/2 wavelengths etc.) When the forces are an integral number of whole wavelengths apart the desired bending wave would not be excited at all, and at intermediate distances an intermediate response amplitude would be obtained.

FIG. 3(b) is a similar illustration corresponding to the desired wave at a different (lower) frequency, where the wavelength is larger. The maximum response there is clearly obtained with the two forces further apart (i.e. with a larger transducer). Thus it can be seen that transducers of different sizes would be desirable in order to excite bending waves most efficiently at different frequencies. The corollary of this is that a single, large fixed size transducer will excite bending waves most efficiently at some specific frequencies but less efficiently at other frequencies. This makes it difficult to achieve a truly flat frequency response with such a transducer.

Most bending wave loudspeakers use moving-coil or moving-magnet transducers to excite the bending waves in the panel. This has been for a number of reasons, one of the principal reasons being the difficulty of getting sufficient power into a panel for a good sound output using piezoelectric drivers.

FIGS. 4 and 5 show piezoelectric transducers equivalent to those conventional transducers in FIGS. 1 and 2.

The transducer of FIG. 4 consists of a layer of active material 42—preferably but not exclusively piezoelectric material—that distorts when subject to an electric field applied between two conductive layers 43, 44 (usually silver) to which electrical signal connections 45, 46 are made. The transducer is fixed to the panel 41 and carries an additional inertial layer 146 having significant mass. Signals applied to the piezoelectric material via the connections cause the material to distort, causing the mass 46 to move and an inertial reaction which generates forces that act transversely to the plane of the panel.

The transducer of FIG. 5 also consists of a layer of piezoelectric material 52 between two conductive layers 53, 54. However, in this case the piezoelectric material is arranged so that it expands and contracts laterally when signals are applied via the connections 55, 56. No mass layer is necessary since the lateral strain created in the piezoelectric layer in a direction parallel to both the plane of the layer and of the panel exerts a bending movement on the panel as a result of being offset from the neutral axis of the panel. The simple transducer of FIG. 5 would be most efficient at producing bending waves of wavelength around twice the lateral extent of the transducer.

Conventional piezo transducers when mounted on a bending wave panel produce a sound that is “bright”, i.e. having excess treble. This is because the power injected by a piezo transducer is proportional to the area of the transducer expressed as a number of wave lengths. As the wave length goes down, the power injected by a transducer goes up. Furthermore, the capacitive nature of the piezoelectric material of the transducer means that it will draw increasing current as drive frequency increases, thereby increasing the injected power by another route.

A further problem with conventional drivers is that the transducer needs to be large in order to provide sufficient power into the panel at low frequencies. However, such a large transducer is ineffective at high frequencies because of an effect known as the “comb filter effect”, which produces many nulls in the frequency response at higher frequencies.

The comb filter effect occurs when the wave lengths of resonant bending waves in the panel becomes small compared with the size of the transducer. A piezo transducer creates bending moments in a panel most easily when the size of the transducer is approximately half of the wave length of the panel. In this case, one end of the transducer can be at a position of large positive displacement while the other end can be at a position of large negative displacement. At higher frequencies, there are frequencies at which each end of the transducer would be moving in phase under the influence of a resonant bending wave in the panel. It is harder to get energies into the panel at these frequencies, and so dips occur in the frequency response, giving rise to the “comb filter” effect.

Piezoelectric transducers have been used in other applications. For example, U.S. Pat. No. 5,031,222 describes a panel-form loudspeaker that uses a plurality of piezoelectric drivers of different sizes to drive a panel. Many of the drivers are provided at nodes of the lowest resonance frequencies of the natural vibration of the diaphragm. Such a location will be the location which excites these lowest modes least. Accordingly, in contradistinction to a distributed mode panel, U.S. Pat. No. 5,031,222 teaches driving the panel at a location which will excite resonances as little as possible. It is clear that the panel is intended to move pistonically backwards and forwards and the intention of the placement of the drivers is to minimise the conversion of energy into any other forms of motion.

Another piezo electric loudspeaker is described in U.S. Pat. No. 5,400,414. In this document an electromechanical transducer is provided made of a piezo-polymer film. In embodiments, the film is arranged in a plurality of concentric circles or other areas of different sizes. This is to control the loudspeaker using a digital audio signal. The surface areas are intended to have areas that are powers of two of the smallest area; each bit of a digital signal can then be used to drive areas of the loudspeaker independently of one other. The listener perceives the sum of the sound fields originating from the individual partial foils and because the areas are power of two with respect to one another the sound output is intended to correspond with the actual analogue audio signal.

Piezoelectric devices are not merely used in conventional loudspeakers. A device suitable for a sonar application of constant beam width over frequency is described in GB 2 296 404.

### SUMMARY OF THE INVENTION

The present invention has as an objective a reduction in the aforementioned problems mentioned as they relate to bending wave loudspeakers.

Accordingly, the present invention involves a loudspeaker comprising a panel adapted to support bending waves, and an exciter coupled to the panel for exciting bending waves in the panel, the exciter having an effective size with which it acts on the panel, wherein the effective size is varied in dependence on the frequency with which the exciter acts on the panel.

Variation in effective exciter size with frequency per the present invention can reduce the aforementioned “comb filter” effect by allowing the exciter to have a larger effective size at low frequencies than at high frequencies. This in turn allows adequate power to be delivered to the panel at low frequencies whilst reducing negative effects at high frequencies.

Such negative effects include increased power transfer into the panel at higher frequencies because, as mentioned above, a larger number of wavelengths fit within the dimensions of the piezoelectric transducer and the transducer will draw increasing current with drive frequency.

Accordingly, a loudspeaker according to the invention sounds less over-bright than a loudspeaker made with a convention piezoelectric transducer.

Furthermore, the reduction in effective size of the transducer with increasing frequency brings with it a reduction in transducer reactance, making the device easier to drive with conventional amplifiers.

The invention also involves a further aspect in an exciter particularly but not exclusively suited for use with the above invention and comprising a layer of active material that distorts when subject to an electric field and electrode layers for applying an electric field to said active layer, wherein at least one of the electrode layers has significant resistivity in the plane of the layer, electrical contact being made to the periphery of said at least one electrode layer.

Yet another exciter suitable for use with the above is comprised in a further aspect of the invention and comprises a layer of active material that distorts when subject to an electric field and electrode layers for applying an electric field to said active layer, at least one of said electrode layers comprising regions of lower resistivity connected by regions of higher resistivity.

Further advantageous embodiments of the invention are set out in the description and claims that follow.

### BRIEF DESCRIPTION OF THE DRAWING

For a better understanding of the invention, examples that embody the best mode for carrying out the invention are described in detail below and are diagrammatically illustrated in the accompanying drawing, in which:

FIG. 6 is a cross-sectional view a first embodiment of the invention using a ‘shrinker’ transducer;

FIG. 7 is a cross-sectional view of a loudspeaker according to a second embodiment of the invention;

FIG. 8 is a plan view of the embodiment of FIG. 7;

FIG. 9 is a graph of the frequency response of an optimised version of the second embodiment;

FIG. 10 is a schematic cross-sectional view of a loudspeaker illustrating the principles behind a third embodiment of the present invention;

FIG. 11 is a cross-sectional view of a transducer according to a fourth embodiment of the present invention;

FIG. 12 is a plan view of the embodiment of FIG. 11;

FIG. 13 is an equivalent circuit diagram for the embodiment of FIGS. 11 and 12;

FIG. 14 is a perspective view of a loudspeaker according to a fifth embodiment of the invention;

FIG. 15 is a plan view of a sixth embodiment of the invention;

FIG. 16 is a plan view of a seventh embodiment of the invention;

FIG. 17 is a cross-sectional view of an eighth embodiment of the invention;

FIG. 18 is a cross-sectional view of another embodiment of the invention employing a plurality of connections;

FIG. 19 is a perspective view of a further embodiment of the invention; and

FIG. 20 is a perspective view of yet another embodiment of the invention.

### DETAILED DESCRIPTION

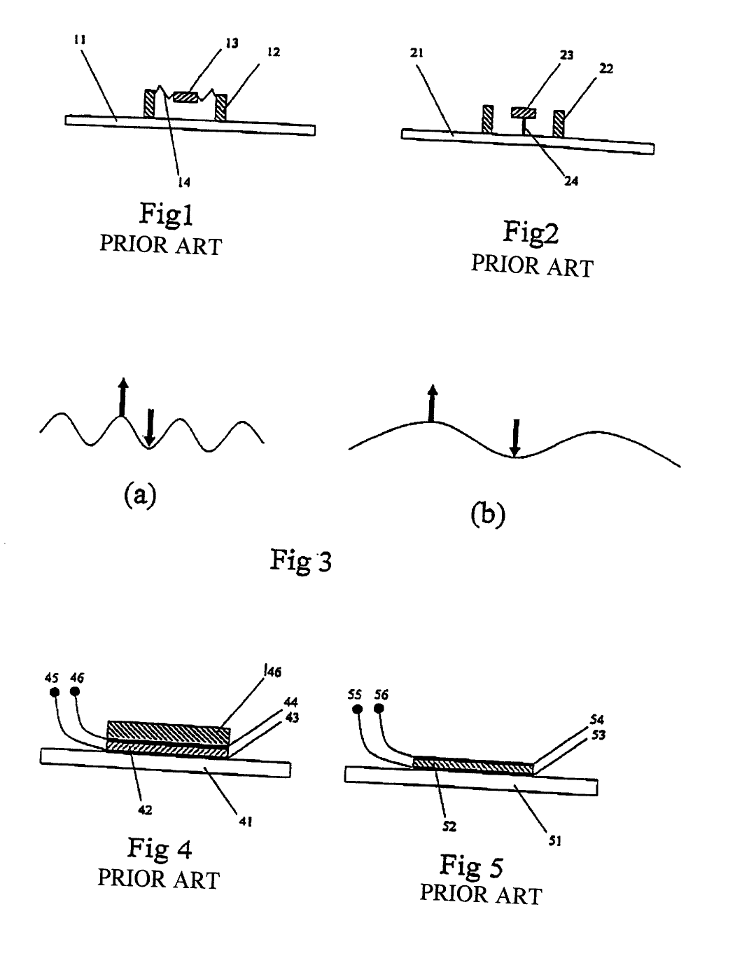

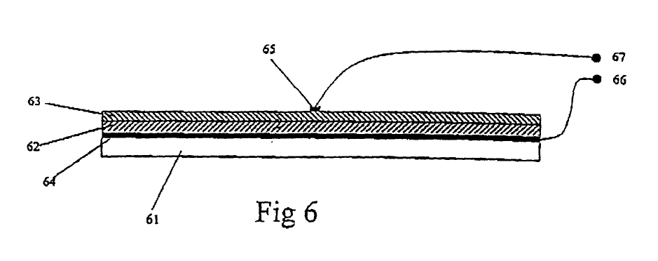

Referring first to FIG. 6, this shows a loudspeaker according to the present invention and using a shrinker transducer of the type described in U.S. Pat. No. 5,764,595. This embodiment also uses a piezoelectric element 62 which is polarised in the same manner as that of the transducer in FIG. 5, and will exert a bending moment on the panel in similar fashion. However, the effective size of the transducer, namely the lateral extent of the active part of the transducer, varies inversely with the frequency at which the transducer acts on the panel, i.e. the effective size increases as the actuation frequency decreases.

To achieve this the active, piezoelectric element 62 is coated with a continuous layer 64 of a good conductor (e.g. silver) on one side only, the other side being coated with a continuous layer 63 of an electrically resistive material. A connection 67 is made to the resistive layer 63 via a small conductive pad 65 on the surface of the layer, and the second signal connection 66 is made directly to the conductive layer 64. Layer 64 is glued (e.g., by photo-mount adhesive) to a panel 61 capable of supporting bending waves.

In accordance with the principles laid down in the aforementioned U.S. Pat. No. 5,764,595 (incorporated herein by reference), the resistivity in the plane of layer 63 is significant, as is the natural capacitance of the piezo material of the transducer. As a result, the device will have an RC time constant that varies in proportion to the area of the transducer which is active, i.e. that area of the transducer which distorts in response to an electric field (the definition of the term ‘active’).

Furthermore, in the case of a circular transducer and a resistive layer 63 of uniform surface resistivity, the effective lateral size of the active part of the transducer—corresponding to the diameter of the active part in a circular transducer—will vary inversely as the square root of frequency. Ideally, such a variation of size should match exactly the dispersion characteristic of flexural waves in plates and the transducer should therefore maintain efficient forcing over a wide range of frequencies.

In addition, the invention allows the use of an exciter that covers the whole of one surface of the panel; this may make it easier to deliver sufficient power.

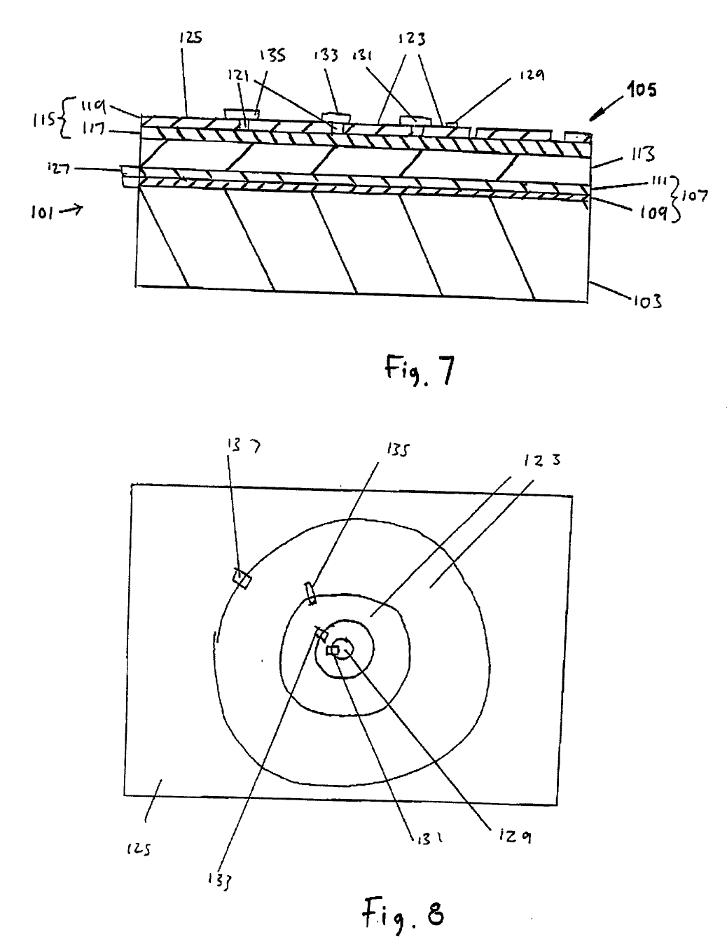

FIGS. 7 and 8 are cross-sectional and plan views respectively of an alternative embodiment 101 of the invention in which the resistivity of the layer varies in the plane of the layer. A transducer 105 covers the whole top surface of a carbon-fibre panel 103 capable of supporting bending waves. The lowest layer of the transducer is the lower electrode assembly 107 which is made up from a sheet of PVDF (polyvinylidene difluoride) 109 having an electrode layer 111 of conductive ink on one side of it. The lower electrode assembly 107 is simply glued to the panel 103 using photo-mount adhesive. Above the lower electrode assembly 107 a piezo-electric layer 113 covers the whole of the lower electrode assembly 107. Above that layer an upper electrode assembly 115 is provided, likewise consisting of a PVDF sheet 117 and an upper electrode layer 119.

A plurality of concentric rings 121 are etched in the upper electrode layer 119 leaving concentric annuli or rings 123 of conductive material and a portion 125 of conductive material outside the rings.

First, second, third and fourth surface mount resistors of significant value (131, 133, 135, 137 in order of distance from the centre of the rings) are provided on the top surface of the electrode element 119 and connect adjacent annular regions 123 of low resistivity electrode material. A terminal 127 is connected at the edge of the lower electrode element and a terminal 129 is located at the centre of the rings, at the innermost of the concentric regions 123.

A number of tests were made with this device. For comparison, a similar device (denoted device A) with an unbroken top electrode was provided. This was compared to tests with a number of different resistor values.

In the first embodiment (denoted device B), the first, second, third and fourth resistors were 1 kΩ surface mounted resistors. In such an arrangement, it will be appreciated that the resistivity in the plane of the layer 115 will increase with increasing distance in the plane from the location (terminal 129) at which the actuating electrical signal is applied. Furthermore, in the case of rings of conducting material joined by discrete resistors, the resistivity will vary in a stepwise fashion determined by the size of the resistors.

In the second embodiment (denoted device C), the resistor values were chosen to mimic a continuous resistive layer of the kind discussed above with regard to FIG. 6 having a 20 kΩ/unit area uniform resistivity. In a third embodiment (device D), the resistor values where chosen to mimic a 30 kΩ/unit area continuous layer.

It was found that the plain electrode device A had several deep notches in its response, the two most obvious being at 2.5 kHz and 7 kHz with many more nulls being visible above 10 kHz. Furthermore, the power output above 1 kHz was much higher than that below, resulting in a bright, phasey sound in subjective listening tests.

The loudspeakers according to the embodiments of the invention (devices B to D) were subjectively much better. Although still bright, they were less bright that the plain electrode transducer (device A) and signals were audible down to 100 Hz, with a reasonable response being obtained down to 150 Hz (although with 15 dB reduction). This compared with a much worse lower frequency response of 250 Hz in the comparison device A.

In order to equalise the frequency response still further, the resistor values were optimised to provide a much flatter overall response. The optimisation was carried out by calculating frequency responses for various resistor values and optimising for the smoothest response using conventional least mean squared methods. This resulted in a 1 ohm resister being used to connect to the inner ring with the first through fourth resistors having the values of 10 ohms, 100 ohms, 150 kilohms, and 75 kilohms respectively.

As is evident from FIG. 9, which shows the variation in rms velocity, V, with log frequency, lf, this optimisation (denoted device E in FIG. 9) yielded a substantially flatter frequency response than that obtained with device B. It is believed that with finer control an even flatter response could be obtained. This could be achieved, for example, by the use of more rings or a continuously variable resistively layer obtained using a conductive ink layer of varying thickness.

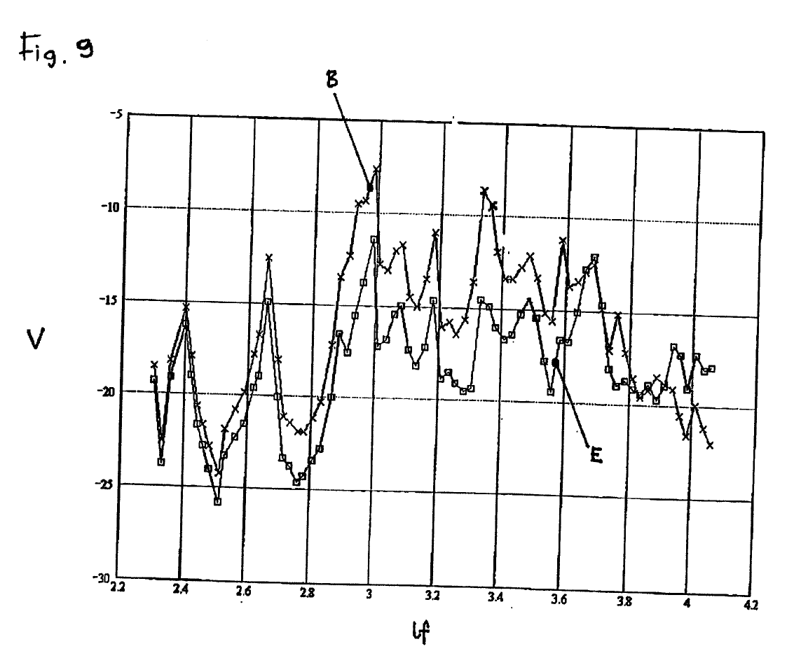

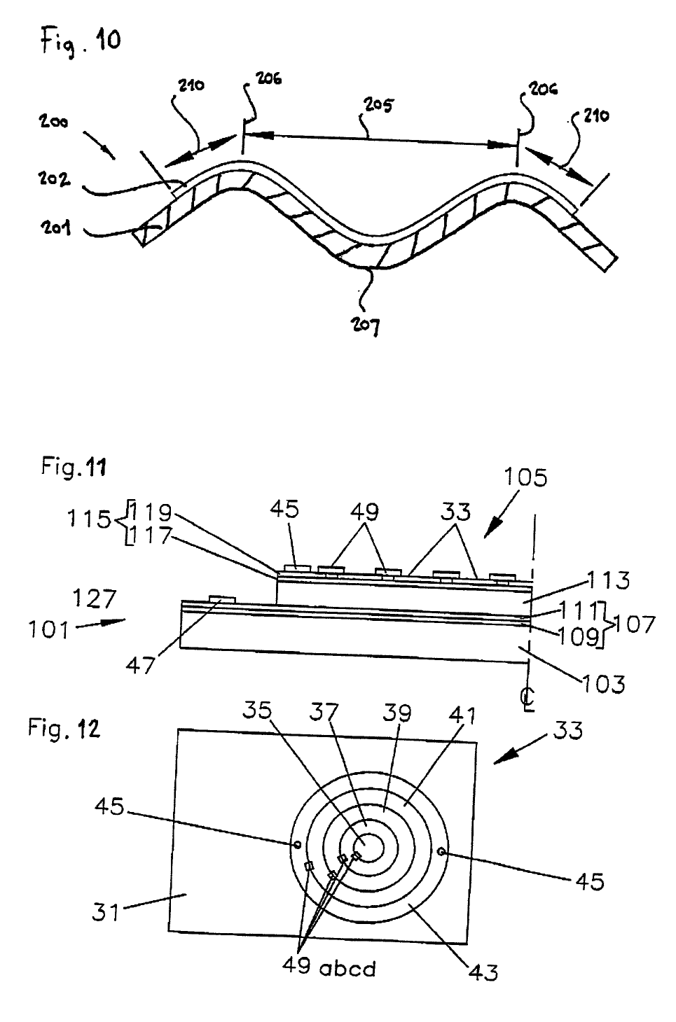

FIG. 10 is a schematic cross-sectional view of a conventional arrangement 200 of panel 201 and transducer 202 of the kind shown in FIG. 5 and when driven in a high frequency mode. The deflection of the arrangement has been exaggerated in the interests of clarity.

It will be apparent that in such a high frequency mode, the central section 205 of the arrangement 200 is effectively redundant: deflection of the panel at the boundaries 206 of the central section is cancelled out by deflection of the panel in the opposite direction at the middle 207 of the central section.

Thus only the edges 210 of the device provide net bending movement, the optimal length for these driven edges being λ/4, where λ is the bending wavelength local to the piezoelectric device. It will be appreciated that as the frequency at which the panel is driven increases, the bending wavelength will decrease and the length of the driven edges—corresponding to the effective size of the transducer—will decrease in accordance with the present invention.

FIG. 11 illustrates a loudspeaker 101 employing the above principle. A carbon-fibre panel 103 which is capable of supporting bending waves has a transducer 105 covering a part of the top surface of the panel. The lowest layer of the transducer is the lower electrode assembly 107 made up from a sheet of PVDF 109 and an electrode layer 111 of conductive ink on one side. This assembly is simply glued to the panel with photo-mount adhesive.

An active piezo-electric layer 113 covers the whole of the lower electrode layer in the region of the transducer 105, and above this an upper electrode assembly 115 is provided, consisting of a PVDF sheet 117 and an upper electrode layer 119. Unlike the lower electrode 111, which is continuous, the upper electrode layer 119 is divided into a plurality of concentric rings or annuli 33 by etching.

As shown in the plan view of FIG. 12, the rings 33 are arranged concentrically from an inner ring 35 through outer rings 37, 39, 41 to an outermost ring 43. Small surface mount resistors 49 join the rings. Terminals 45, 47 are provided on upper and lower electrode assemblies 115, 107.

The above arrangement is equivalent to the RC circuit shown in FIG. 13 and having a plurality of resistors 49a-d and a plurality of capacitors 35, 37, 39, 41, 43 arranged in a ladder arrangement. When an acoustic signal is applied at one end of the RC ladder, the time constants of the components of the ladder are such that at higher frequencies only the outermost piezoelectric ring is driven, whereas at a steadily lower frequency more and more of the inner rings are driven. In this way, the piezoelectric device is driven approximately in accordance with the optimal arrangement outlined above, where the piezoelectric device is driven only by the outer quarter wavelength.

Since the capacitance, C, of a circuit is chiefly determined by the area of the rings and piezoelectric material of the transducer, variation in values of the resistors between rings is left as the main means of tuning the circuit.

Consider, for example, a transducer of the kind illustrated in FIG. 12 and having four regularly spaced rings 37, 39, 41 and 43 of respective inside radius r1=13 mm, r2=28 mm, r3=43 mm and r4=58 mm, and capacitance c1=0.47 nF, c2=1.50 nF, c3=2.53 nF, c4=3.47 nF.

As will be clear from the explanation above, the radial extent of adjacent actuated rings needs to correspond to one quarter of the bending wavelength, λ, at a given frequency, i.e. r4−ri=λ/4 where i=1 to 4. The bending wavelength, λ, at a given frequency ω is in turn given by the well-known formula λ(ω)=2.π. ((B/μ)^{1/2}/ω)^{1/2}), where B is the static bending stiffness of the panel and μ is the mass/area ratio. Substituting the first expression into the second and rearranging yields a formula for the given frequency as follows: ω=[π/(2.(r4−ri))]². [B/μ]^{1/2}. In this example, B and μ are 0.35 Nm and 0.46 kg/m² respectively.

It will also be appreciated from the explanation above regarding FIG. 12 that to achieve appropriate driving of the rings, the aforementioned given frequency should correspond to the break frequency, 1/RC, for the circuit comprising the adjacent actuated rings. In this case, R will correspond to the sum of the resistors 49 between a particular ring and the connection 45, and C will correspond to the capacitance of the ring in question. Equating the expression for the break frequency with the expression for ω and solving allows the values of resistor 49 to be determined that will ensure that the variation in transducer effective size matches the variation in frequency. For the ring dimensions and capacitances given above, the corresponding resistance values are (with reference to FIG. 13) 49a=3 kΩ, 49b=15 kΩ, 49c=51 kΩ and 49d=330 kΩ.

The above example is based on a transducer having rings that are regularly spaced. However, it will be clear from the calculation above that other values of ring radius can be chosen to achieve particular break frequencies, perhaps corresponding to preferred resonant frequencies of the panel, or to allow particular values of resistance to be used. In this regard, resistor values that are all equal may be desirable from a cost point of view.

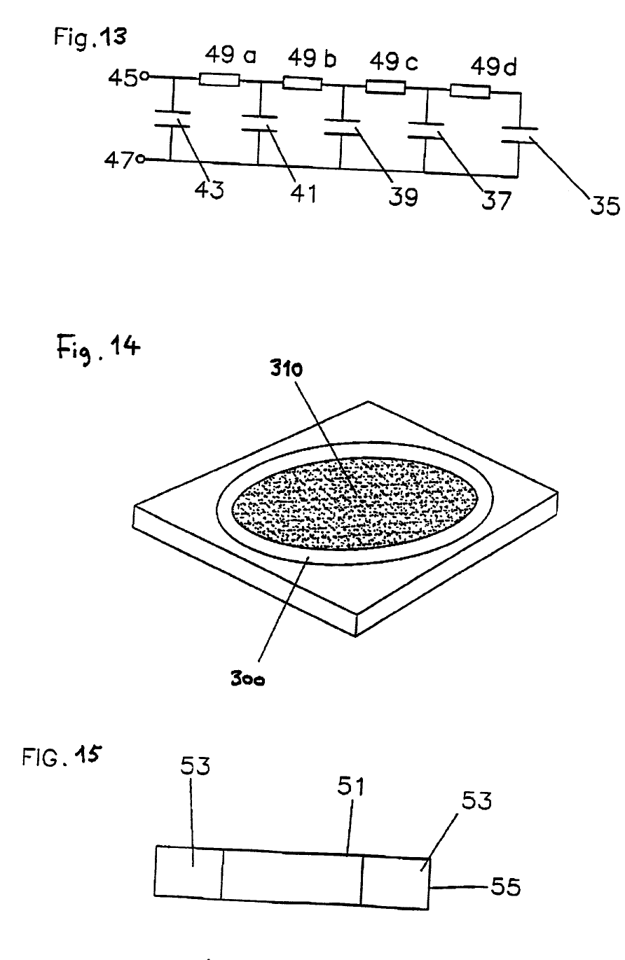

In place of conductive rings connected by discrete resistors, the further embodiment of FIGS. 11 and 12 may be implemented using a resistive ink layer. Such an arrangement, shown in FIG. 14, advantageously includes a conductive ring 300 of silver or the like which surrounds resistive layer 310 and from which an electrical connection to driver electronics can be made. Ink layer 30 may be graded so as to give a resistivity that increases with radius in a manner analogous to the previous embodiment. In both discrete and continuous resistor embodiments, an electrical connection to the periphery of the transducer rather than to its centre reduces any propensity for arcing and overheating at the contacts.

FIG. 15 is a plan view of beam-type piezoelectric actuator incorporating the above concept and comprising an inner element 51 surrounded by an outer element 53 in two portions one at each end of a beam 55. At higher frequencies only the outer element is driven, whereas at lower frequencies both are driven. A piezoelectric actuator of this form gives substantially the same output as a fully driven device, but has a higher input impedance and a lower reactive input impedance. As with the circular actuator discussed above, discrete resistors may be replaced by a continuous resistive layer.

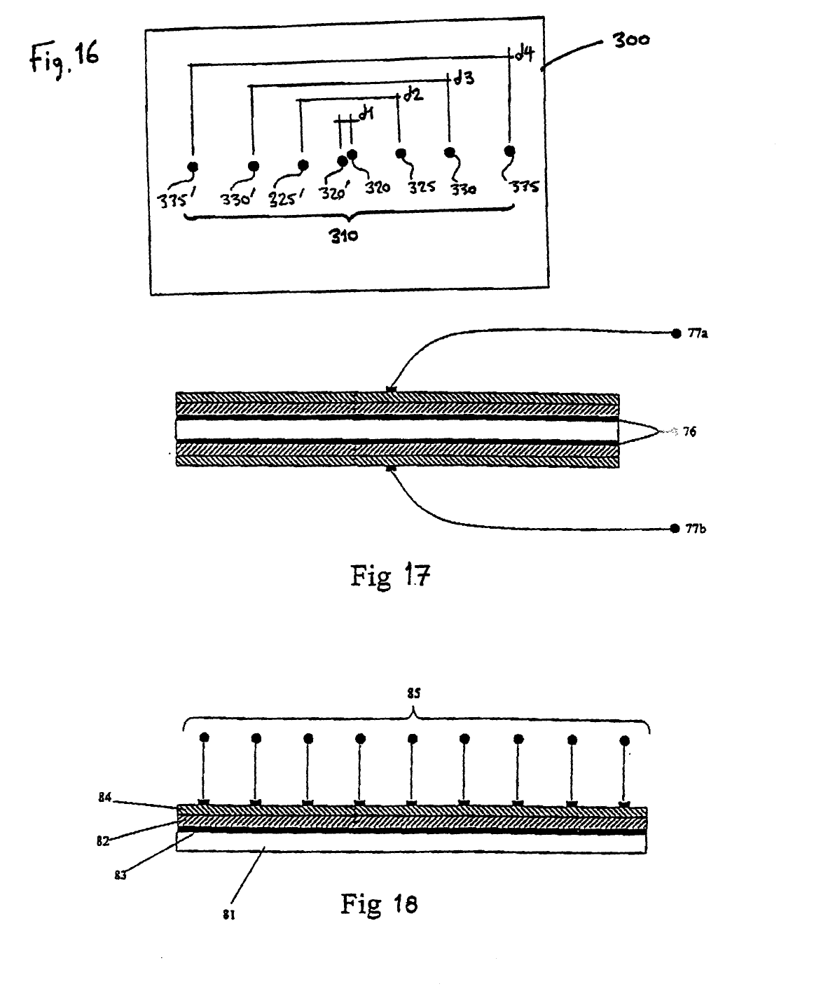

FIG. 16 is a plan view of a panel 300 incorporating a further embodiment of the inventive concept of the invention. Unlike earlier embodiments, the transducer is not unitary and monolithic but comprises a line 310 of individual exciters grouped in pairs (320, 320′; 325, 325′; 330, 330′; 335, 335′) and spaced by respective distances d1, d2, d3 and d4. In a manner analogous to WO 00/13464 and counterpart U.S. application Ser. No. 09/384,419, filed Aug. 27, 1999 (both belonging to the assignee of this application, the latter incorporated herein by reference), pairs of exciters are fed equal and opposite signals so as to generate a torsion couple in the panel. In accordance with the invention, exciter pairs are chosen for driving in dependence on the frequency of the driving signal: at low frequencies, those pairs (330, 330′; 335, 335′) having a large separation d3, d4 may be actuated to provide a larger effective size of transducer suited to the larger bending wavelength of the panel at such low frequencies. Conversely, the smaller bending wavelengths that occur at higher frequencies will be advantageously excited by those pairs (320, 320′; 325, 325′) having a small separation. It will be appreciated that such lower-separated transducer pairs may also be operated in concert with the higher-separated pairs whenever the latter are operated, the effect being to increase the power transmitted to the panel at low frequency/large bending wavelength conditions.

The torsion couple can of course also be obtained from a monolithic, unitary beam actuator of the kind discussed above with regard to FIG. 15 if the electrical contacts are arranged such that opposite ends of the beam move in opposite directions.

FIG. 17 shows a development of the transducer of FIG. 6 in which a plurality of exciters are mounted on the panel, in the case shown on respective opposite sides of the panel. When driven in anti-phase (push-pull) by electrical signals applied to the connections 76 and 77 the bending moment is applied symmetrically to the panel. This can increase the vibrational power input and improve the overall linearity of the system.

FIG. 18 shows another development of the basic transducer of FIG. 6. Instead of a single connection being made to the resistive layer 84, an array of connections 85 is made thereby allowing the actuation signal to be applied at a plurality of locations. Piezo layer 82 and lower electrode 83b remain the same as in FIG. 6. This arrangement can be used to increase the power input to the system and/or to control its directivity as a loudspeaker. If the array of connections 85 is distributed non-periodically over the resistive surface rather than regularly as shown, then this arrangement can be adjusted in order to achieve a more diffuse flexural wavefield in the panel 81. Current practice suggests that in some specialised applications, diffusion leads to a better quality of sound.

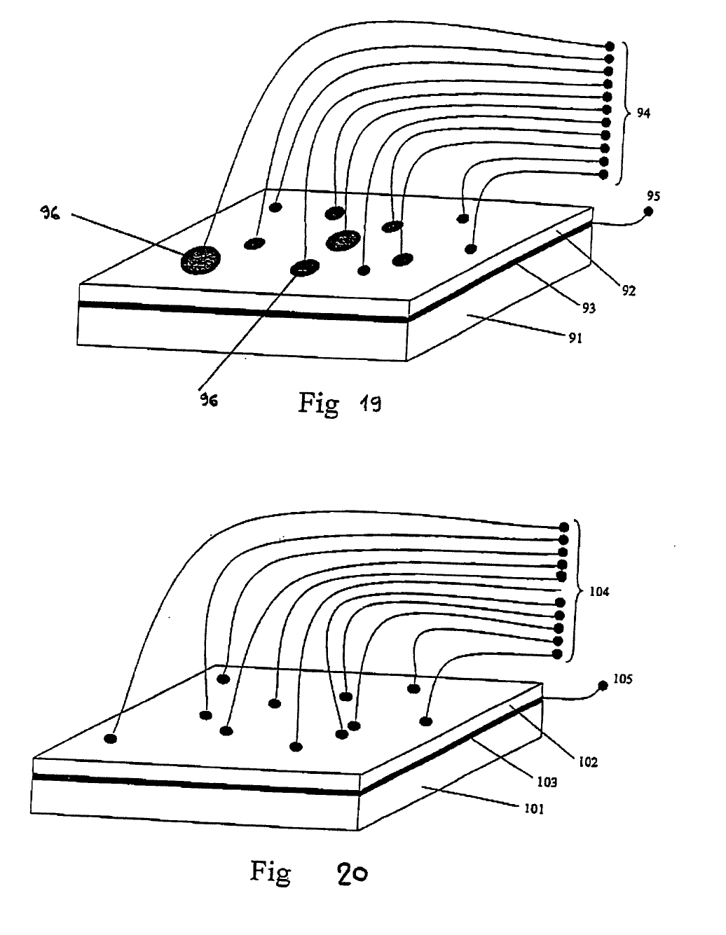

FIG. 19 shows an alternative method of assuring efficient excitation of flexural waves over an extended frequency range. Here an active piezoelectric layer 92 is coated on one side only by a conductive layer 93. The other side of the piezoelectric layer carries a series of discrete regions, namely conductive pads 96, of differing area. These pads are connected to terminals 94 which in turn are provided with signal voltages (sourced e.g. from a digital signal processing device) in dependence on the frequency of the incoming signal. A common return terminal 95 is connected to the conductive layer 93. The pads will be most efficient at different frequencies, in accordance with their sizes, and a flat frequency response may be obtained by choosing the distribution of sizes and number of pads carefully. The pads can be distributed regularly over the surface or unevenly as shown.

FIG. 20 shows a similar device to that in FIG. 19 but instead of varying the size of the pads, only their spacing on the active piezoelectric layer is varied. The moments produced by adjacent pairs of connections will depend on the distance they are apart and the relative phases of the signals applied to the array of connections.

It will be appreciated from the explanation of bending wave excitation given with regard to FIGS. 1-3 above that signals can be applied to various of the pairs of discrete regions in dependence on the frequency of the signal, with the separation of the pairs of discrete regions to which a signal is applied increasing with decreasing frequency of that signal.

It will also be understood that although the invention has been described in the context of—and indeed is particularly suited to—a piezoelectric, first-order, linear electrically-active ceramic, the invention may be used with any material which distorts when subject to an electric field. Such materials (e.g. quartz or rochelle salt), although less active than PZT ceramic, nevertheless undergo a change in dimension when subject to an electric field and as such could be used in an actuator.

1. A loudspeaker comprising:
a panel adapted to support bending waves, and
an exciter coupled to the panel for exciting bending waves in the panel, the exciter having an effective size with which it acts on said panel, wherein said effective size is varied in dependence on the frequency with which the exciter acts on the panel.

2. A loudspeaker according to claim 1, wherein said panel is adapted for distributed mode operation.

3. A loudspeaker according to claim 1, wherein said effective size increases as said frequency decreases.

4. A loudspeaker according to claim 3, wherein said exciter comprises a layer of active material that distorts when subject to an electric field, and electrode layers for applying an electric field to said active layer.

5. A loudspeaker according to claim 4, wherein at least one of the electrode layers has significant resistivity in its own plane.

6. A loudspeaker according to claim 5, wherein said resistivity varies in the plane of the layer.

7. A loudspeaker according to claim 6, wherein said exciter is actuated by an electrical signal applied to a location on said at least one electrode layer, the resistivity of the layer increasing with increasing distance in the plane from said location.

8. A loudspeaker according to claim 7, wherein said at least one electrode layer is continuous.

9. A loudspeaker according to claim 7, wherein at least one of said electrode layers comprises resistive ink.

10. A loudspeaker according to claim 8, wherein said exciter is actuated by an electrical signal, the signal being applied to said continuous electrode layer at a plurality of locations.

11. A loudspeaker according to claim 10, wherein said locations are distributed evenly over the resistive surface.

12. A loudspeaker according to claim 4, wherein at least one of the electrode layers comprises regions having low resistivity in the plane of its layer connected by resistors of significant value.

13. A loudspeaker according to claim 12, wherein said regions are defined by etching of a conductive layer.

14. A loudspeaker according to claim 12 or claim 13, wherein said regions are concentric.

15. A loudspeaker according to claim 14, wherein said exciter is actuated by an electrical signal, the signal being applied to the innermost of the concentric regions.

16. A loudspeaker according to claim 4, wherein the exciter comprises a layer of said active material and electrode layers for applying an electric field to the layer of active material, at least one of the electrode layers comprising discrete regions of differing area; and wherein said exciter is actuated by an electrical signal, said signal being applied to various of said discrete regions in dependence on the frequency of said signal.

17. A loudspeaker according to claim 16, wherein the area of a discrete region to which said signal is applied increases with decreasing frequency of the electrical signal.

18. A loudspeaker according to claim 4, wherein the exciter comprises a layer of said active material and electrode layers for applying an electric field to said layer of active material; wherein at least one of the electrode layers comprises a plurality of pairs of discrete regions, the separation in the plane of the layer of the pairs of discrete regions being different between pairs; and wherein the exciter is actuated by an electrical signal, said signal being applied to various of said pairs of discrete regions in dependence on the frequency of said signal.

19. A loudspeaker according to claim 18, wherein the separation of the pairs of discrete regions to which said signal is applied increases with decreasing frequency of the electrical signal.

20. A loudspeaker according to any one of claims 4, 12, 16 and 18, wherein said active material is piezoelectric material.

21. A loudspeaker according to any one of claims 1, 2, 3, 4, 12, 16 and 18, wherein said exciter covers the whole of one surface of the panel.

22. A loudspeaker according to any one of claims 1, 2, 3, 4, 12, 16 and 18, wherein there are a plurality of said exciters coupled to the surface of the panel.

23. A loudspeaker according to claim 22, wherein a pair of exciters are arranged on respective opposite surfaces of a panel.

24. A loudspeaker according to any one of claims 4, 12, 16 and 18, wherein said exciter generates forces acting transversely to the plane of the layer of active material.

25. A loudspeaker according to claim 24, wherein said exciter includes a layer other than said layer of active material and which has significant mass.

26. A loudspeaker according to any one of claims 4, 12, 16 and 18, wherein said exciter generates forces acting parallel to the plane of the layer of active material.

27. A loudspeaker according to claim 26, wherein said layer of active material expands in a direction parallel to the plane of the panel.

28. A loudspeaker according to claim 14, wherein said exciter is actuated by an electrical signal, the signal being applied to the outermost of the concentric regions.

29. A loudspeaker according to any one of claims 1, 2, 3 and 4, wherein said exciter is unitary and monolithic.

30. A loudspeaker according to any one of claims 1, 2, 3 and 4, wherein said exciter is made up of a plurality of sub-exciters.

31. A loudspeaker according to claim 30, wherein said sub-exciters are arranged in pairs spaced over the panel and actuated so as to exert a torsion couple on said panel.

32. A loudspeaker according to claim 31, wherein said pairs of sub-exciters are spaced by differing amounts over the panel, respective pairs being actuated in dependence on frequency, thereby varying the effective size of the exciter with frequency.

33. A loudspeaker according to claim 32, wherein respective pairs are actuated in dependence on respective frequencies, each pair being actuated at its said respective frequency and at all frequencies below said respective frequency.

34. An exciter comprising a layer of active material that distorts when subject to an electric field, and electrode layers for applying an electric field to said active layer, at least one of said electrode layers comprising regions of lower resistivity connected by regions of higher resistivity.

35. An exciter according to claim 34, wherein said regions of higher resistivity comprise discrete resistive elements.

36. An exciter according to claim 34, wherein one of said an electrode layers has regions of lower resistivity having differing dimensions, electrical contact being made to the region having the lowest dimensions.

37. An exciter according to claim 34, wherein one of said electrode layers has regions of lower resistivity having differing dimensions, electrical contact being made to the region having the greatest dimensions.

38. An exciter comprising a layer of active material that distorts when subject to an electric field, and electrode layers for applying an electric field to said active layer, wherein at least one of the electrode layers has significant resistivity in the plane of the layer, electrical contact being made to the periphery of said at least one electrode layer.

39. A loudspeaker comprising:
a panel adapted to support bending waves and behave as a distributed mode acoustic radiator, and
an exciter coupled to the panel for exciting bending waves in the panel, the exciter having an effective size with which it acts on the panel, said effective size varying inversely as a function of the frequency with which the exciter acts on the panel.
